(19) United States
(12) Patent Application Publication
(10) Pub. No.: US 2008/0210481 A1
(43) Pub. Date: Sep. 4, 2008

(54) Electric Drive System Comprising Differential Steering for a Vehicle, Drive Unit and Vehicle

(75) Inventors: Ralf Boss, Kressbronn (DE); Hans-Peter Freudenreich, Griesingen (DE)

Correspondence Address: DAVIS BUJOLD & Daniels, P.L.L.C., 112 PLEASANT STREET, CONCORD, NH, 03301, US

(73) Assignee: ZF Friedrichshafen AG, Friedrichshafen (DE)

(21) Appl. No.: 11/916,579

(22) PCT Filed: Jun. 7, 2006
(86) PCT No.: PCT/EP2006/005418

§ 371 Date: Dec. 5, 2007

(30) Foreign Application Priority Data
Jun. 10, 2005 (DE) 102005027117.0

(51) Int. Cl. B62D 11/04

(52) U.S. Cl. 180/65.7; 180/6.5

(57) ABSTRACT

An electric drive system for a vehicle features two similar drive units, an electric energy source, an electronic control unit and a left and a right summation gear, which are configured as planetary gears. A drive unit drives the ring gear of the left summation gear, while the other drive unit drives the ring gear of the right summation gear. The ring gear of the left summation gear has a direct drive connection with the sun gear of the right summation gear, while the ring gear of the right summation gear has a direct drive connection with the sun gear of the left summation gear by way of a second mechanical gearset. A left sun gear shaft is proposed running through a left hollow shaft toward the center of the vehicle and a right sun gear shaft running through a right hollow shaft toward the center of the vehicle.

This application is a national stage completion of PCT/EP2006/005418 filed Jun. 7, 2006, which claims priority from German Application Serial No. 10 2005 027 117.0 filed Jun. 10, 2005.

### FIELD OF THE INVENTION

The invention relates to an electric drive system for a motor vehicle with skid steering, a gear unit of such a system and a vehicle equipped with it.

### BACKGROUND OF THE INVENTION

Vehicles with skid steering are tracked vehicles or wheeled vehicles in which, for the purpose of driving in a curve, the track on the inside of the curve or the drive wheels on the inside of the curve, respectively, are decelerated relative to the track on the outside of the curve or the drive wheels on the outside of the curve. Heavy tracked vehicles in particular require considerable braking power on the track on the inside of the curve to do this.

There are different known systems that allow the use of this braking power in that it is fed to the track on the outside of the curve. In a mechanical or hydrostatic-mechanical, cross-drive, steering transmission with a steering transmission unit and a driving transmission unit, as disclosed in DE 38 33 784 A1, a neutral shaft driven by the steering transmission unit is provided for this purpose. The exchange of power from the track on the inside of the curve to the track on the outside of the curve takes place mechanically by way of the drive transmission unit.

In the diesel electric drive unit disclosed in DE 100 05 527 A, each of the two tracks is assigned to its own electric drive unit where there is no mechanical drive connection between them. The transmission of power, between the left and right side, takes place exclusively electronically, which allows an arrangement of the drive elements that is favorable in terms of installation space, but which requires a correspondingly powerful electrical unit and a powerful electrical drive unit. EP 0 304 594 also presents a diesel electric drive unit which, in addition, also features a mechanical, cross-drive, steering transmission. An electric drive motor of a different installation size is provided for drive and steering operation, respectively. With this drive unit, there is a mechanical transmission of power between the left and right sides exclusively. However, this known drive unit is very complex and is not optimal in terms of installation space as it requires not only one diesel motor and a complex mechanical, cross-drive, steering transmission, but also a powerful generator and two electric drive units. When driving straight ahead, strain is put only on the drive motor while the power, installed in the steering drive motor, is not used.

WO 02/083483 A discloses a drive unit in which similar electric drive units are arranged on either side and in which, in addition, a central third electric motor is provided as a steering motor.

U.S. Pat. No. 5,445,234 discloses a drive system for a vehicle with skid steering with a left and a similar right electric drive unit. In this electric drive system, both electric drive units serve, at the same time, as drive units and steering drives. The fully installed electrical power is available for driving straight ahead. The transfer of power, between the left and the right side, takes place partially mechanically and partially electrically. A summation gear, configured as a planetary transmission, is arranged on each side. The planet carriers of these two summation gears form the two outputs that act on the crawlers. The sun gear of the left numeration gear is driven by way of a spur-gearset by the left drive unit and the sun gear of the right summation gear by means of a spur-gearset by the right drive unit. The two sun gears of the left and right summation gears are connected in a rotationally fixed manner by way of a connecting shaft. In addition, there is a gearset arranged between the sun gear of the left summation gear and the sun gear of the right summation gear, the gearset coupling the two drive units. In order for the two drive units to be operated at different speeds when driving in a curve, this gearset features a differential gear in the center.

And finally, WO 2005/039958 A1, which is seen as obviously similar, discloses an electrical drive system for a vehicle with skid steering with a left and a similar right electric drive unit with a combination of a diesel motor and a generator as sources of electrical energy; an electronic control unit for independent control of the speeds of the two drive units with a left and a similar right summation gear, which is configured as a planetary transmission where the planetary carriers form the output and where the ring gear of the left summation gear can be driven by way of a direct drive connection with the left drive unit and the ring gear of the right summation gear can be driven by way of a direct drive connection with the right drive unit, and where the ring gear of the left summation gear has a direct connection with the sun gear of the right summation gear by way of a first mechanical gearset and the ring gear of the right summation gear has a direct connection with the sun gear of the right summation gear, and the ring gear of the right summation gear has a direct drive connection with the sun gear of the left summation gear by way of a second mechanical gearset.

This electro-mechanical drive system advantageously features only a few different components and two similar drive units. Both drive units are used for actuating both driving and steering. In addition, by way of the mechanical transfer of power, between the left and right sides, the drive system also features a very good degree of efficiency so that relatively small and compact electrical drive units can be used.

With this system, however, the mechanical, cross-wise drive connection, between the left and the right summation gear, is realized by way of connecting shafts that pass externally around the summation gear. This arrangement requires relatively long connecting shafts and is restrictive with regard to compact structural shape.

The present invention is, therefore, based on describing a generic drive system, a transmission unit for it and a vehicle that is equipped with it in which, by way of a more compact structural shape, better exploitation of the limited installation space can be achieved.

### SUMMARY OF THE INVENTION

In the case of the inventive electric drive system, the ring gear characterized as the “left” ring gear of the left summation gear is deposed on a “left” hollow shaft. In this hollow shaft, the shaft that is referred to as the “left” sun gear shaft, which carries the sun gear of the left summation gear, runs toward the center of the vehicle. Symmetrically to it, a “right” sun gear shaft runs through a “right” hollow shaft on which the “right” ring gear is deposed toward the center of the vehicle. The drive connection, between the ring gear of the left summation gear and the sun gear of the right summation gear and between the ring gear of the right summation gear and the sun gear of the left summation gear, is so produced that the left hollow shaft has a direct drive connection with the right sun gear shaft and the right hollow shaft has a direct drive connection with the left sun gear shaft. In the context of the present invention, having a “direct drive connection” means that rotation of one component is directly associated with a rotation of the other component. A direct drive connection can be a rotationally fixed connection or also a connection by way of a gear chain of a gearset.

Advantageously, the cross-wise attachment of the ring or the sun gears of the two summation gears is not done externally around the summation gears, but rather along the main axis of the summation gears in concentrically nesting rotating shafts. A large number of much shorter connecting shafts can be used, which can also be arranged in the area of the center of the vehicle and inside one of the cylinder chambers defined by the two hollow gears of the summation gear. In that way, all mechanical transmission elements are concentrated with high packing density in a compact transmission housing.

The direct drive connections can then be established in a simple manner by way of a drive connection, between the left hollow shaft and the right sun gear shaft through a first intermediate shaft, on which a first and a second gear wheel are deposed, where the first gear wheel engages a third gear wheel deposed on the left hollow shaft and the second gear wheel a fourth gear wheel deposed on the right sun gear shaft and by way of a drive connection between the right hollow shaft and the left sun gear shaft, by way of a second intermediate shaft on which a fifth and a sixth gear wheel are deposed, where the fifth gear wheel engages a seventh gear wheel deposed on the right hollow shaft and the sixth gear wheel an eighth gear wheel deposed on left sun gear shaft.

In this embodiment of the invention, the configuration of the transmission can be symmetrical, where each component, including the intermediate shafts with the gear wheels deposed on them, is employed doubly. On the whole, in this manner, only a few different components are necessary for assembly, which offers major advantages with regard to manufacturing costs and maintaining a stock of spare parts.

In an additional embodiment of the invention, the two drive units are arranged offset opposite to a center axis of the summation gears. The left ring gear can thereby be driven by the first drive unit by way of a gear pair that is formed by the ninth gear wheel arranged on an output shaft of the first drive unit and a tenth gear wheel arranged on the left hollow shaft. The right ring gear can be driven by the second drive unit by way of a gear pair that is formed by an eleventh gear wheel arranged on an output shaft of the second drive unit and a twelfth gear wheel that is arranged on the right hollow shaft.

The advantage of this embodiment of the invention is that a composite construction method is achieved in which the electric drive units can be arranged externally. They are then easily accessible for maintenance work, among other things. The offset arrangement of the two drive units opposite to the center axis of the summation gears makes it possible to arrange them where free installation space is available, for example above the crawlers.

An additional advantage of this embodiment of the invention is that the installation length of the transmission can be considerably reduced.

If extreme demands are made on both the climbing ability of the vehicle and the maximum speed to be achieved, it is possible to establish a drive connection selectively and with varying shiftable transmission ratios between the first drive unit and the left ring gear and the second drive unit and the right ring gear. The additional cost of the transmission that results from the extra transmission ratios and the necessary shifting elements, such as multiple-plate clutches or dog couplings, pays off because smaller, lighter and more cost-efficient electric drive units can be used.

### BRIEF DESCRIPTION OF THE DRAWINGS

The invention will now be described, by way of example, with reference to the accompanying drawings in which:

FIG. 1 is a schematic depiction of a vehicle with skid steering;

FIG. 2 is a schematic depiction of an electric drive system for a vehicle with skid steering;

FIG. 3 is a schematically different embodiment of drive units with flange-mounted electric drive units;

FIG. 4 is another schematically different embodiment of drive units with flange-mounted electric drive units;

FIG. 5, is yet another schematically different embodiment of drive units with flange-mounted electric drive units; and

FIG. 6 is still another schematically different embodiment of drive units with flange-mounted electric drive units.

### DETAILED DESCRIPTION OF THE INVENTION

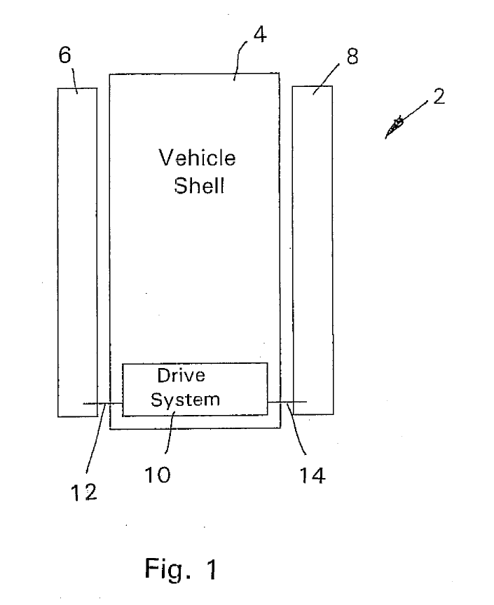

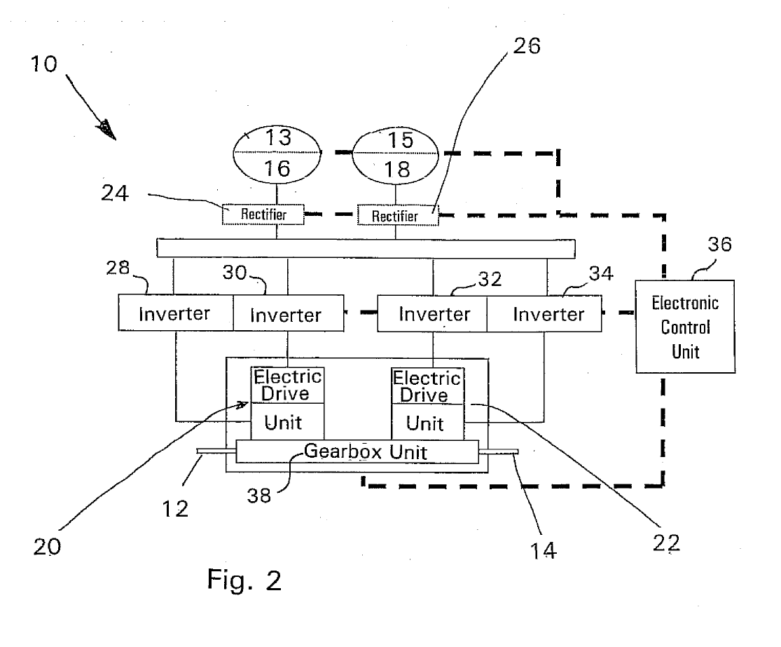

In FIGS. 1, 2 designates a vehicle with skid steering which, in addition to a shell 4 feature a left crawler 6, a right crawler 8 and an electric drive system 10 whose output shafts 12, 14, drive the two crawlers 6, 8.

As shown in FIG. 2, the electric drive system 10 features two similar electric drive units 20, 22, which feature two independent windings that can be controlled independently. A combination of diesel motors 13, 15 and electric generators 16, 18 serve as sources of electric energy. The electric generators 16, 18 are electrically connected to the electric drive units 20, 22 by way of power electronics comprising rectifiers 24, 26, and the inverters 28, 30, 32, 34. The individual components are controlled by an electronic control unit 36 by way of signal lines shown by dotted lines in such a way that independently determined, specified speeds are adjusted for the drive units 20, 22. A gearbox unit 38 features the two output shafts 12, 14 for driving the two crawlers.

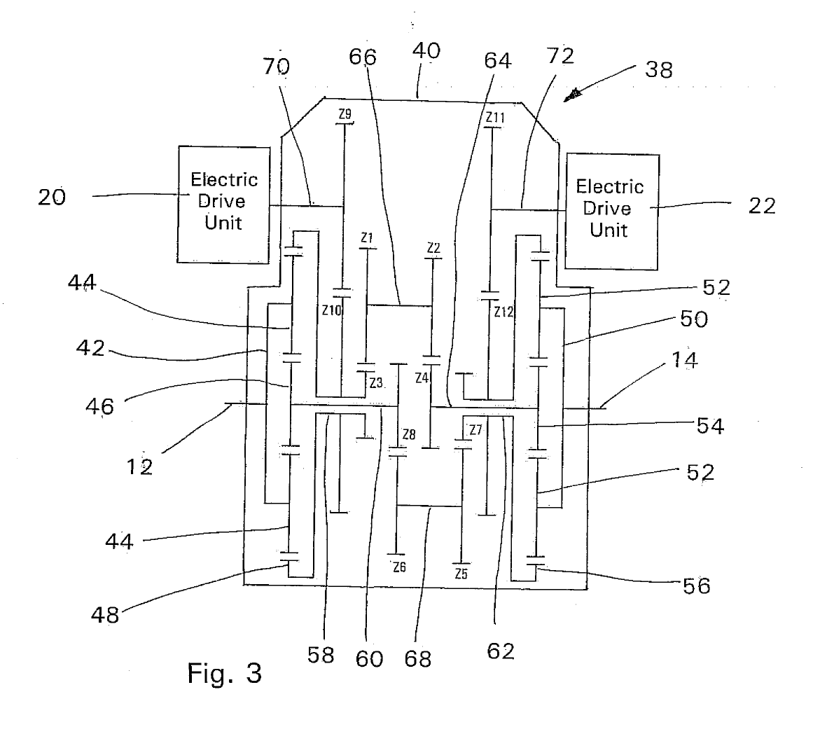

The drive unit 38, shown in FIG. 3, is driven by the two electric drive units 20, 22. All mechanical transmission sites are accommodated in one transmission housing 40, which features the left output 12 and the right output 14. The output shaft 12 is connected with a planetary carrier 42 of the left summation gear on which a plurality of planetary gears 44 are mounted so as to rotate and which simultaneously engage a sun gear 46 and a ring year 48. Correspondingly, the right summation gear is identically constructed and is formed by the planetary carrier 50, planetary gears 52, a sun gear 54, and a ring gear 56. The “left” ring gear 48 of the left summation gear is deposed on a hollow shaft 58, through which the “left” sun gear shaft 60 runs toward the center of the vehicle. The hollow shaft 58 has a drive connection with the right sun gear shaft 64 by way of a first intermediate shaft 66, on which a gear wheel Z1 and a gear wheel Z2 are arranged. The gear wheel Z1 engages gear wheel Z3 that is deposed on the left hollow shaft and the gearwheel Z2 engages the gearwheel Z4 that is deposed on the right sun gear shaft 64. The drive connection of the right hollow shaft 62 with the left sun gear shaft 60 is produced by a second intermediate shaft 68 on which the gear wheel Z5 and the gear wheel Z6 are arranged. The gear wheel Z5 engages a gear wheel Z7 that is deposed on the right hollow shaft 62 and the gear wheel Z6 engages a gear wheel Z8 that is deposed on the left sun gear shaft 60.

The left hollow shaft 58 or the left ring gear 48 can be driven directly by the left drive unit 20. A gear pair is used for this purpose, which is formed by a gear wheel Z9 that is arranged on an output shaft 70 of the left drive unit 20 and a gear wheel Z10 that is arranged on the left hollow shaft 58.

Both electrical drive units 20, 22 are arranged parallel offset to the central axis of the two summation gears.

In a corresponding manner, the right hollow shaft 62 or the right ring gear 56, can be driven directly by the right electric drive unit 22. A gear wheel Z11 serves this purpose and is arranged on the output shaft 72 of the right electric drive unit 22 and engages a gear wheel Z12, which is arranged on the right hollow shaft 62.

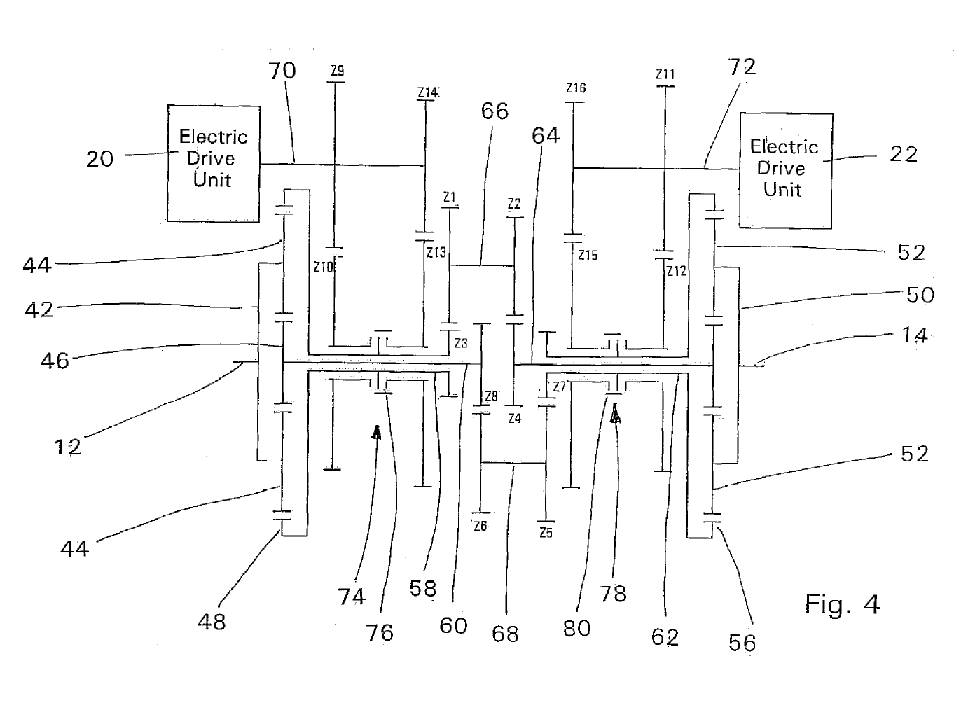

The embodiment, shown in FIG. 4, is different from the embodiment shown in FIG. 3 in that the left drive unit 20 can have a drive connection with the left ring gear 48, and the right drive unit 22 with the right ring gear 56, selectively and with different shiftable transmission ratios. In other respects, the same reference signs as in FIG. 3 are used in FIGS. 4, 5 and 6.

A dog coupling 74 that serves as a shifting element is arranged on the left hollow shaft 58. Depending on the switching point of a sliding sleeve 76, the gear wheel Z10 or a gear wheel Z13 can be coupled selectively with the left hollow shaft 58. Positioned adjacent to the gear wheel Z9 on the output shaft 70 of the left electric drive unit 20 is a gear wheel Z14, which engages the gear wheel Z13. For high torque demands, for example with steep upward slopes, drive is provided by way of the gear wheel pair Z14, Z13 while, for the highest vehicle speeds, drive is provided by the gear wheel pair Z9, Z10. Instead of the schematically shown dog coupling 74, a power-shiftable hydraulic, multiple-plate clutch can also be used as a shifting element.

On the right side, the shiftable transmission ratios are formed in a corresponding manner by way of a dog coupling 78, a sliding sleeve 80, a gear wheel Z15 and a gearwheel Z16.

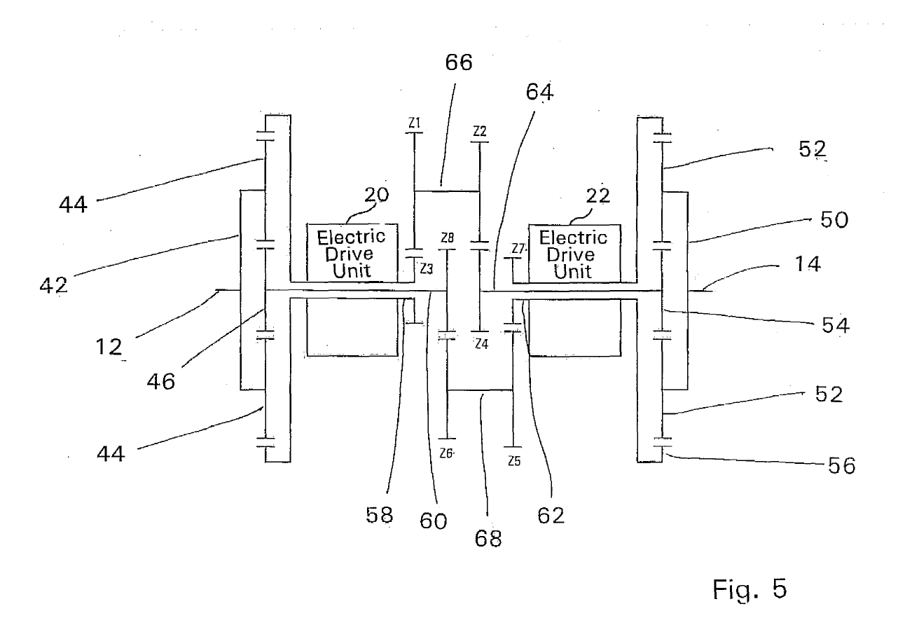

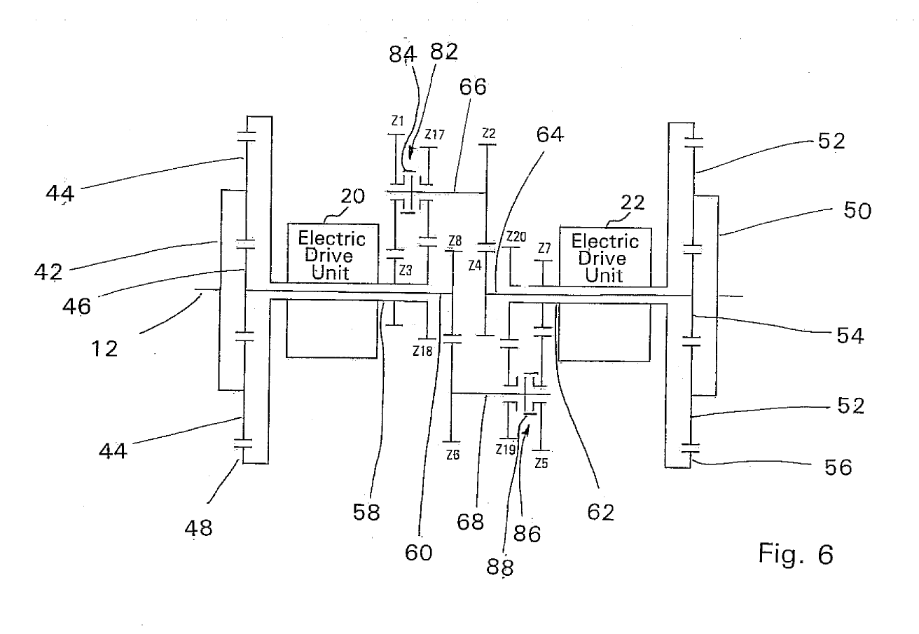

FIGS. 5 and 6 show alternative embodiments of the inventive electric drive system in which the two drive units 20, 22 are arranged concentrically on the left hollow shaft 58 or the right hollow shaft 62. Both the hollow shafts 58, 62 and the sun gear shafts 60, 64 pass through the electric drive units. The respectively assigned hollow shaft is, at the same time, the output shaft of the electric drive units.

FIG. 6 shows an embodiment of the invention in which the left electric drive unit 20 can have a drive connection, selectively and with different shiftable transmission ratios, with the right sun gear 54 and the right electric drive unit 22 with the left sun gear 46.

For this purpose, a dog coupling 82 is arranged on the first intermediate shaft 66 as a shifting element. By displacing a sliding sleeve 84 of the dog coupling 82, the gear wheel Z1 or a gear wheel Z17 can be selectively coupled with the first intermediate shaft 66, while the gearwheel Z1 constantly engages the gear wheel Z3 deposed on the left hollow shaft 58 and the gear wheel Z17 constantly engages a gear wheel Z18, which is also deposed on the left hollow shaft 58. In a corresponding manner, a dog coupling 86 is arranged on the second intermediate shaft 68. By displacing a sliding sleeve 88, the gear wheel Z5 or a gearwheel Z19 can be selectively coupled with the second intermediate shaft 68, while the gear wheel Z5 constantly engages the gear wheel Z7 that is deposed on the right hollow shaft 62 and the gear wheel Z19 constantly engages a gear wheel Z20, which is also deposed on the right hollow shaft 62.

Reference numerals

| | |
|---|---|
| 2 | vehicle |
| 4 | vehicle shell |
| 6, 8 | crawlers |
| 10 | drive system |
| 12, 14 | output shafts |
| 13, 15 | combustion engines |
| 16, 18 | electric generators |
| 20, 22 | electric drive units |
| 24, 26 | rectifiers |
| 28, 30, 32, 34 | inverters |
| 36 | electronic control unit |
| 38 | gearbox unit |
| 40 | transmission housing |
| 42 | planetary carrier |
| 44 | planetary gears |
| 46 | sun gear |
| 48 | ring gear |
| 50 | planetary carriers |
| 52 | planetary gears |
| 54 | sun gear |
| 56 | ring gear |
| 58 | hollow shaft |
| 60 | sun gear shaft |
| 62 | hollow shaft |
| 64 | sun gear shaft |
| 66 | intermediate shaft |
| 68 | intermediate shaft |
| 70 | drive unit output shaft |
| 72 | drive unit output shaft |
| 74 | dog coupling |
| 76 | sliding sleeve |
| 78 | dog coupling |
| 80 | sliding sleeve |
| 82 | dog coupling |
| 84 | sliding sleeve |
| 86 | dog coupling |
| 88 | sliding sleeve |
| Z1 to Z20 | gear wheels |

1-10. (canceled)

11. An electric drive system (10) for a vehicle (2) with skid steering, the electric drive system (10) comprising:
at least a first electric drive unit (20) and a second electric drive unit (22);
an electrical energy source (13, 16; 15, 18) communicating with the first electric drive unit (20) and the second electric drive unit (22);
an electronic control unit (36) communicating with the first electric drive unit (20) and the second electric drive unit (22) for independently controlling a drive speed of the first electric drive unit (20) and the second electric drive unit (22);
a left planetary gearset summation gear having a left planetary carrier (42), a left ring gear (48), and a left sun gear (46), the left planetary carrier (42) being a left drive output (12) and the left ring gear (48) being fixed to a left hollow shaft (58);
a right planetary gearset summation gear having a right planetary carrier (50), a right ring gear (56), and a right sun gear (54), the right planetary carrier (50) being a right drive output (14) and the right ring gear (56) being fixed to a right hollow shaft (62);
the left ring gear (48) being driven by the first electric drive unit (20) and the right ring gear (56) being driven by the second electric drive unit (22);
the left ring gear (48) driving, via a first mechanical gearset (58, Z3, Z1; 66, Z2 Z4; 64), the right sun gear (54), and the right ring gear (56) driving, via a second mechanical gearset (62, Z7, Z5; 68, Z6, Z8; 60), the left sun gear (46);
a left sun gear shaft (60) passing through a left hollow shaft (58) toward a center of the vehicle and a right sun gear shaft (64) passing through a right hollow shaft (62) toward the center of the vehicle; and
the left hollow shaft (58) having a direct drive connection with the right sun gear shaft (64), and the right ring gear (56) having a direct drive connection with the left sun gear shaft (60).

12. The electric drive system according to claim 11, wherein the drive connection between the left hollow shaft (58) and the right sun gear shaft (64) comprises a first intermediate shaft (66) to which a first gear wheel (Z1) and a second gear wheel (Z2) are fixed, the first gear wheel (Z1) engages a third gear wheel (Z3) fixed to the left hollow shaft (58), and the second gear wheel (Z2) engages a fourth gear wheel (Z4) fixed to the right sun gear shaft (64), and the drive connection between the right hollow shaft (62) and the left sun gear shaft (60) comprises a second intermediate shaft (68) to which a fifth gear wheel (Z5) and a sixth gear wheel (Z6) are fixed, the fifth gear wheel (Z5) engages a seventh gear wheel (Z7) fixed to the right hollow shaft (62), and the sixth gear wheel (Z6) engages an eighth gear wheel (Z8) fixed to the left sun gear shaft (60).

13. The electric drive system according to claim 11, wherein the left ring gear (48) is driven by the first electric drive unit (20) via engagement of a gear wheel pair comprising a ninth gear wheel (Z9), fixed to an output shaft (70) of the first electric drive unit (20), and a tenth gear wheel (Z10), coupleable with the left hollow shaft (58), the right ring gear (56) is driven by the second electric drive unit (22) via engagement of a gear wheel pair comprising an eleventh gear wheel (Z11), fixed to an output shaft (72) of the second electric drive unit (22), and a twelfth gear wheel (Z12), coupleable with the right hollow shaft (62), and the first electric drive unit (20) and the second electric drive unit (22) are offset from a center axis which is common to the left planetary gearset summation gear and the right planetary gearset summation gear.

14. The electric drive system according to claim 11, wherein the drive transmitted from the first electric drive unit (20) to the left ring gear (48) is transmitted at different, selectively shiftable transmission ratios and the drive transmitted from the second electric drive unit (22) to the right ring gear (56) is transmitted at different, selectively shiftable transmission ratios.

15. The electric drive system according to claim 13, wherein the left hollow shaft (58) has a shifting element (74) which selectively couples one of the tenth gear wheel (Z10) and a thirteenth gear wheel (Z13) with the left hollow shaft (58), the tenth gearwheel (Z10) engages the ninth gearwheel (Z9), fixed to the output shaft (70) of the first electric drive unit (20), and the thirteenth gear wheel (Z13) engages a fourteenth gear wheel (Z14), also fixed to the output shaft (70) of the first electric drive unit (20), and the right hollow shaft (62) has a shifting element (78) which selectively couples one of the twelfth gear wheel (Z12) and a fifteenth gear wheel (Z5) with the right hollow shaft (62), the twelfth gear wheel (Z12) engages the eleventh gear wheel (Z11), fixed to the output shaft (72) of the electric drive unit (22), and the fifteenth gear wheel (Z15) engages a sixteenth gear wheel (Z16), also fixed to the output shaft (72) of the second electric drive unit (22).

16. The electric drive system according to claim 11, wherein the first electric drive unit (20) is located concentrically on the left hollow shaft (58) and the second drive machine (22) is located concentrically on the right hollow shaft (62).

17. The electric drive system according to claim 14, wherein the drive transmitted from the first electric drive unit (20) to the right sun gear (54) is transmitted at different, selectively shiftable transmission ratios and the drive transmitted from the second electric drive unit (22) to the left sun gear (46) is transmitted at different, selectively shiftable transmission ratios.

18. The electric drive system according to claim 17, wherein a first intermediate shaft (66) has a shifting element (82), which selectively couples one of a first gear wheel (Z1) and a seventeenth gear wheel (Z17) to the first intermediate shaft (66), the first gear wheel (Z1) engages a third gear wheel (Z3), fixed to the left hollow shaft (58), and the seventeenth gear wheel (Z17) engages an eighteenth gear wheel (Z18), also fixed the left hollow shaft (58), and the second intermediate shaft (68) has a shifting element (86), which selectively couples one of a fifth gearwheel (Z5) and a nineteenth gear wheel (Z19) to a second intermediate shaft (68), the fifth gear wheel (Z5) engages a seventh gear wheel (Z7), fixed to the right hollow shaft (62), and the nineteenth gear wheel (Z19) engages a twentieth gear wheel (Z20), also fixed on the right hollow shaft (62).

19. The electric drive unit of an electric drive system according to claim 11, wherein at least a first summation drive and a second summation drive are combined in one housing (40).

20. An electric drive system (10) in combination with for a vehicle (2) with skid steering, the electric drive system (10) comprising:
at least a first electric drive unit (20) and a second electric drive unit (22);
an electrical energy source (13, 16; 15, 18) communicating with the first electric drive unit (20) and the second electric drive unit (22);
an electronic control unit (36) communicating with the first electric drive unit (20) and the second electric drive unit (22) for independently controlling drive speeds of the first electric drive unit (20) and the second electric drive unit (22);
a left planetary gearset summation gear having a left planetary carrier (42), a left ring gear (48), and a left sun gear (46), the left planetary carrier (42) being a left drive output (12) and the left ring gear (48) being fixed to a left hollow shaft (58);
a right planetary gearset summation gear having a right planetary carrier (50), a right ring gear (56), and a right sun gear (54), the right planetary carrier (50) being a right drive output (14) and the right ring gear (56) being fixed to a right hollow shaft (62);
the left ring gear (48) being driven by the first electric drive unit (20) and the right ring gear (56) being driven by the second electric drive unit (22);
the left ring gear (48) driving, via a first mechanical gearset (58, Z3, Z1; 66, Z2 Z4; 64), the right sun gear (54), and the right ring gear (56) driving, via a second mechanical gearset (62, Z7, Z5; 68, Z6, Z8; 60), the left sun gear (46);
a left sun gear shaft (60) passing through the left hollow shaft (58) toward a center of the vehicle and a right sun gear shaft (64) passing through the right hollow shaft (62) toward the center of the vehicle; and
the left hollow shaft (58) having a direct drive connection with the right sun gear shaft (64), and the right ring gear (56) having a direct drive connection with the left sun gear shaft (60).
